(19) United States
(12) Patent Application Publication
(10) Pub. No.: US 2026/0156573 A1
(43) Pub. Date: Jun. 4, 2026

(54) WIRELESS DEVICE WITH INITIATIVE POWER-SAVING MECHANISM, AND METHOD FOR OPERATING A WIRELESS DEVICE

(71) Applicant: MEDIATEK INC., Hsinchu City (TW)

(72) Inventors: Yen-Yu LIN, Hsinchu City (TW); Tsung-Che LU, Hsinchu City (TW); Kuan-Po LIU, Hsinchu City (TW)

(21) Appl. No.: 18/964,325

(22) Filed: Nov. 29, 2024

(51) Int. Cl. H04W 52/02

(52) U.S. Cl. CPC H04W 52/0235; H04W 52/0216

(57) ABSTRACT

An initiative power-saving mechanism for a wireless device is shown. A transmitter of the wireless device transmits a first-type null frame to an access point, and then transmits packets to the access point in multiple transmission windows. The first-type null frame carries power-saving off information. Each of the transmission windows is followed by a power-saving window without having the wireless device transmit any second-type null frame that carries power-saving on information. The transmission windows are designed for an active mode. The power-saving windows are designed for a power-saving mode that consumes less power than the active mode.

### BACKGROUND OF THE INVENTION

### FIELD OF THE INVENTION

The present invention relates to a wireless device of wireless communication.

### Description of the Related Art

Power saving (PS) is a critical key success factor (KSF) for battery-powered wireless devices. Chip and device vendors invest significant time and resources in reducing the power consumption to enhance battery life and improve product competitiveness.

The IEEE 802.11 standards define several power-saving modes, including a legacy power-saving mode and Wi-Fi Multimedia (WMM) power-saving mode, along with the procedures for transition between a power-saving mode and an active mode. Chip vendors and device makers are committed to facilitate mode changes with greater precision and minimal impact on latency.

Conventionally, after transmitting or receiving a packet, a wireless device, such as a station (STA), enters the power-saving mode to conserve power. Taking the receiving step as an example, in the power-saving mode, the wireless device periodically receives beacons from an access point (AP), which notifies the wireless device of the packets buffered on the AP side. In such a design, the wireless device may experience traffic latency. It takes longer time for the wireless device in the power-saving mode to access the buffered packets than in an active mode.

To mitigate the long latency, a conventional wireless device utilizes a brief period prior to the power-saving mode as a listening period, to confirm that there is indeed no traffic. For example, the wireless device may spend 200 ms in listening before entering the power-saving mode. The 200 ms listening period is referred to as a Keep Alive Time (KAT). If there is no traffic during the KAT, the prolonged latency is prevented, and the wireless device transits to the power-saving mode.

However, in high throughput scenarios, such as a live streaming, busy traffic is always detected in the listening period (KAT). There is not even a chance for switching from the active mode to the power-saving mode. The wireless device always in the active mode consumes considerable power. Similar problem can be seen on the transmitting step of a wireless device.

### BRIEF SUMMARY OF THE INVENTION

An initiative power-saving (IPS) mechanism for a wireless device is shown.

A wireless device with an initiative power-saving mechanism in accordance with an exemplary embodiment of the disclosure has a transmitter (TX) that transmits packets to an access point (AP). The transmitter transmits a first-type null frame to the access point, and then transmits packets to the access point in multiple transmission windows. The first-type null frame carries power-saving off information. Each of the transmission windows is followed by a power-saving window without having the wireless device transmit a second-type null frame that carries power-saving on information. The transmission windows are designed for an active mode. The power-saving windows are designed for a power-saving mode that consumes less power than the active mode.

In an exemplary embodiment, the wireless device further has a receiver (RX) that receives packets from the access point. In response to a beacon, the wireless device transmits the first-type null frame to inform the access point that the wireless device starts a receiving window to receive packets. The receiving window can be controlled by a timer.

In an exemplary embodiment, the wireless device further transmits a second-type null frame to the access point after the receiving window, to change to the power-saving mode.

According to the aforementioned concept, several methods for operating the wireless device are also presented in the disclosure.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a wireless network 100 in accordance with an exemplary embodiment of the disclosure;

FIG. 2 depicts the operations of a transmitter (TX) 108 in accordance with an exemplary embodiment of the disclosure;

FIG. 3 depicts the operations of a receiver (RX) 110 in accordance with an exemplary embodiment of the disclosure;

FIG. 4 is a flowchart depicting the operations of the transmitter 108 in accordance with an exemplary embodiment of the disclosure;

FIG. 5 is a flowchart depicting the operations of the receiver 110 in accordance with an exemplary embodiment of the disclosure; and

FIG. 6 illustrates a computer program product 602 storing program code 604 to be loaded into a storage device 606 of the wireless device 102 and executed by a processor 608 of the wireless device 102 to implement the initiative power-saving method.

### DETAILED DESCRIPTION OF THE INVENTION

The following description enumerates various embodiments of the disclosure, but is not intended to be limited thereto. The actual scope of the disclosure should be defined according to the claims. The various blocks and modules mentioned below may be implemented by a combination of hardware, software, and firmware, and may also be implemented by special circuits. The various blocks and modules are not limited to being implemented separately, but can also be combined together to share certain functions.

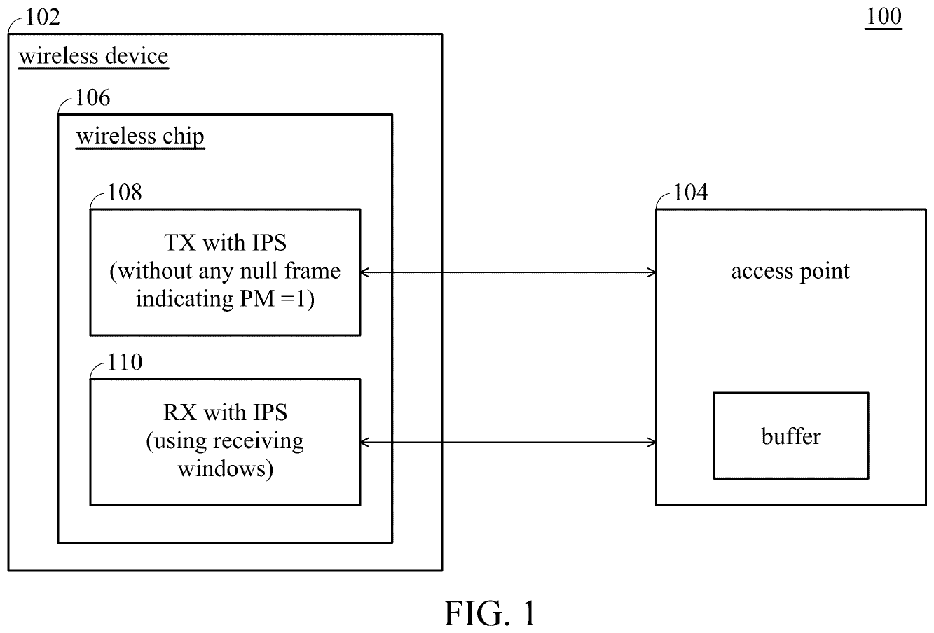

FIG. 1 depicts a wireless network 100 in accordance with an exemplary embodiment of the disclosure. A wireless device 102 (e.g., a station) communicates with an access point (AP) 104. The wireless device 102 has a wireless chip 106. The wireless chip 106 has a transmitter (TX) 108 operative to transmit packets to the access point 104, and a receiver (RX) 110 operative to receive packets from the access point 104. The transmitter 108 and the receiver 110 are designed according to an initiative power-saving (IPS) mechanism. The concept of the initiative power-saving mechanism is to proactively trigger the entry into a power-saving mode.

There are two types of null frames for the transmitter 108 and the receiver 110 to communicate with the access point 104. The first-type null frame carries power-saving off information. In an exemplary embodiment, the power-saving off information is presented by a flag PM which is set to 0. The transmitter 108 may use the first-type null frame to inform the access point 104 that the transmitter 108 is ready to transmit packets (to change from a power-saving mode to an active mode that consumes more power than the power-saving mode). The wireless device 102 may use the first-type null frame to inform the access point 104 that the receiver 110 is ready to receive packets. The second-type null frame carries power-saving on information (for changing from the power-saving mode to the active mode). In an exemplary embodiment, the power-saving on information is presented by asserting the flag PM to 1. Based on the initiative power-saving mechanism, the packet transmission may switch to from the active more to the power-saving mode without transmitting any second-type null frame (a null frame with PM=1). In this manner, the wireless device 102 saves power by omitting the redundant transmission of the second-type null frames. As for the packet receiving using the initiative power-saving mechanism, the second-type null frame (a null frame with PM=1) is still required, to inform the access point 104 to buffer the packets because the packet receiving is in the power-saving mode. Before the wireless device 102 transmits the second-type null frame to the access point 104, the receiver 110 allows the receiving traffic (e.g., do receiving) in a limited receiving window. The length of the receiving window can be defined by a timer, not by whether the entire target receiving task is completed. Thus, the receiver 110 in some high throughput scenarios still periodically switches to the power-saving mode. The power consumption is considerably reduced.

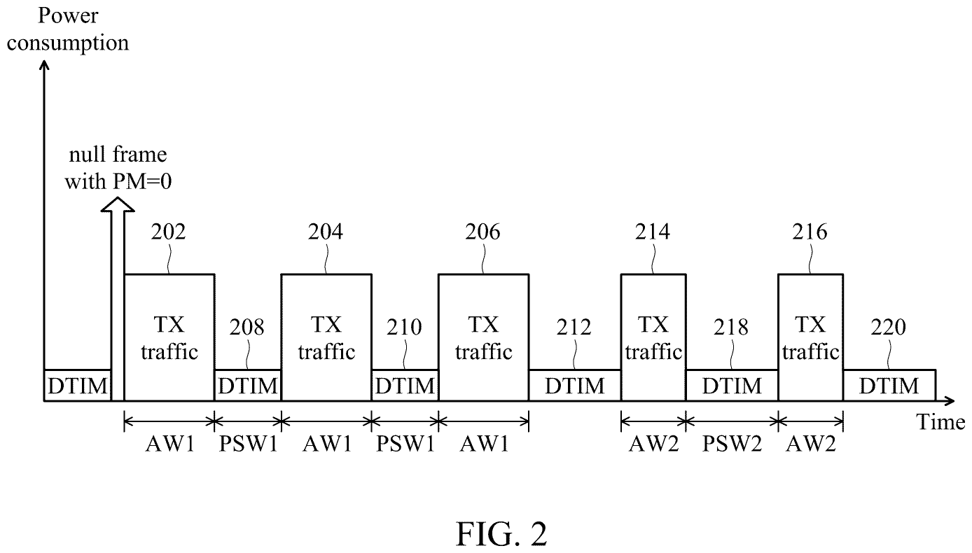

FIG. 2 depicts the operations of a transmitter (TX) 108 in accordance with an exemplary embodiment of the disclosure. In FIG. 2, there are two exemplary target transmission tasks (numbered by “1” and “2”). The transmitter 108 transmits a first-type null frame (PM=0) to inform the access point 104 of the transmission about the two target transmission tasks. As shown, each transmission task is not completed in one go. Instead, the transmitter 108 allows transmission traffic of each target transmission task in separated transmission windows. Each of the transmission windows is followed by a power-saving window without having the transmitter 108 transmit a second-type null frame that carries power-saving on information (PM=1). In each transmission window, the transmitter 108 is in an active mode and the transmission traffic is allowed. In each power-saving window, the transmitter 108 is in a power-saving mode that consumes less power than the active mode. In the figure, the power-saving mode is represented by DTIM, an abbreviation of Delivery Traffic Indication Map. The transmitter 108 initiatively switches from the active mode (TX traffic) to the power-saving mode (operating based on DTIM). No second-type null frames carrying the power-saving on information (PM=1) is required between the mode switching.

In the illustrated example, the transmitter 108 transmits the first-type null frame (PM=0) to indicate the transmission of the target transmission tasks, and then allows transmission traffic of the first target transmission task in transmission windows 202, 204, and 206, and the transmission traffic of the second target transmission task in transmission windows 214 and 216. Without any second-type null frame, the transmission windows 202, 204, 206, 214 and 216 are followed by the power-saving windows 208, 210, 212, 218, and 220, respectively. The transmission windows 202, 204, and 206 about the first transmission task have the same length (AW1). Before the transmission traffic of the first target transmission task is completed in the transmission window 206, the power-saving windows 208 and 210 have the same length (PSW1). The transmission windows 214 and 216 about the second transmission task have the same length (AW2). Before the transmission traffic of the second target transmission task is completed in the transmission window 216, the power-saving window 218 is in a length of PSW2. The transmitter 108 waiting for the next transmission task in the power-saving window 220. In an exemplary embodiment, an second null frame with PM=1 can be sent after multiple transmission windows and power-saving windows.

In an exemplary embodiment, the greater throughput corresponds to the wider transmission window, and/or the greater throughput corresponds to the narrower power-saving window. In the example illustrated in FIG. 2, the throughput of the first target transmission task is greater than the throughput of the second target transmission task. As shown, the length AW1 of each transmission window 202/204/206 is longer the length AW2 of each transmission window 214/216. The length PSW1 of the power-saving window 208/210 is shorter the length PSW2 of the power-saving window 218.

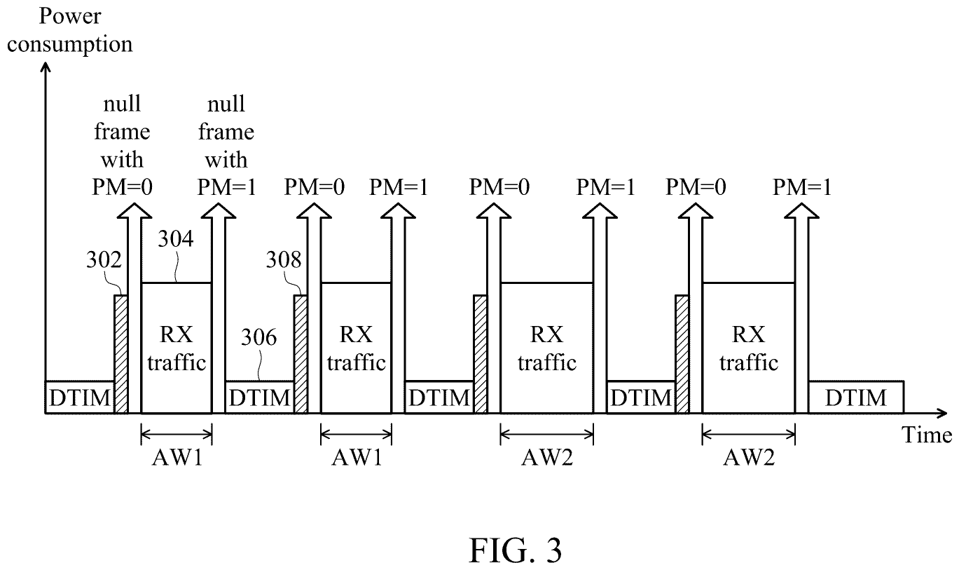

FIG. 3 depicts the operations of the receiver (RX) 110 in accordance with an exemplary embodiment of the disclosure. In response to a beacon 302, the wireless device 102 transmits a first-type null frame (with PM=0) to inform the access point 104 that the receiver 110 is ready to receive the buffered packets. The receiver 110 allows the receiving traffic in a limited receiving window 304. The receiving window 304 may be closed by a timer, not by the completion of the entire target receiving task. After the limited length (AW1) of the receiving traffic, the wireless device 102 transmits a second-type null frame (with PM=1) to request the access point to buffer the subsequent packets, and then the wireless device 102 switches to the power-saving mode 306 to wait for the next beacon 308.

In an exemplary embodiment, the greater throughput corresponds to the wider receiving window. The illustrated example shows the increased throughput. The length of the receiving window, therefore, is increased from the AW1 to AW2.

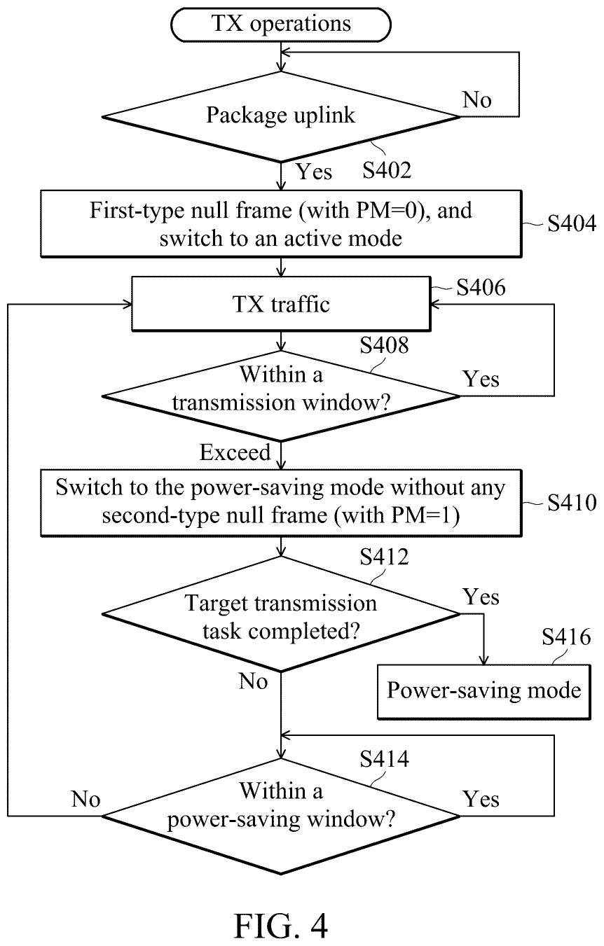

FIG. 4 is a flowchart depicting the operations of the transmitter 108 in accordance with an exemplary embodiment of the disclosure. In step S402, the transmitter 108 determines whether to uplink packets to the access point 104. If yes, step S404 is performed. The transmitter 108 transmits a first-type null frame (with PM=0) to inform the access point 104 of a target transmission task, and the wireless device 102 switches to the active mode. In step S406, the transmitter 108 allows the transmission traffic. In S408, the transmitter 108 determines whether the transmission exceeds a transmission window. If the transmission exceeds the transmission window, step S410 is performed. The wireless device 102 switches to the power-saving mode without any second-type null frame (with PM=1). In step S412, the transmitter 108 determines whether the whole target transmission task is completed. If not, step S414 is performed. The transmitter 108 determines whether the power-saving mode of the transmitter 108 exceeds a power-saving window. If yes, the procedure returns to step S406 to continue the rest of the target transmission task in the following transmission windows.

If step S412 determines that the whole target transmission task is completed, step S416 is performed. The wireless device 102 stays in the power-saving mode till the next transmission task happens. The transmitter 108 with such an initiative power-saving mechanism achieves good balance between the throughput and power saving.

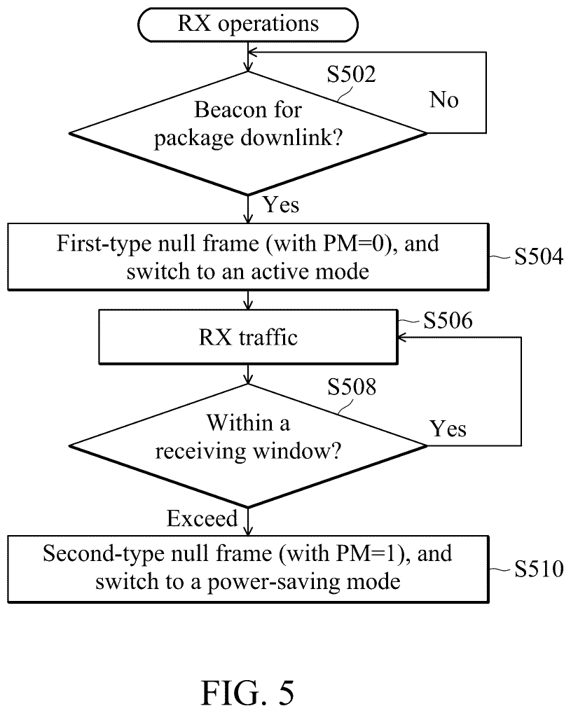

FIG. 5 is a flowchart depicting the operations of the receiver 110 in accordance with an exemplary embodiment of the disclosure. In step S502, it is determined whether a beacon from the access point 104 is received by the receiver 110 for packet downlink. If yes, step S504 is performed. The wireless device 102 transmits a first-type null frame (with PM=0) to inform the access point 104 of the ready status of the receiver 110, and switches to the active mode. In step S506, the receiver 110 allows the receiving traffic (i.e., do receiving). In S508, the receiver 110 determines whether the receiving traffic exceeds a receiving window. If the receiving traffic exceeds the receiving window, step S510 is performed. The wireless device 102 transmits a second-type null frame (with PM=1) to inform the access point 104 to buffer the following downlink packets, and switches to the power-saving mode to wait for the next beacon. The receiver 110 with such an initiative power-saving mechanism also achieves good balance between the throughput and power saving.

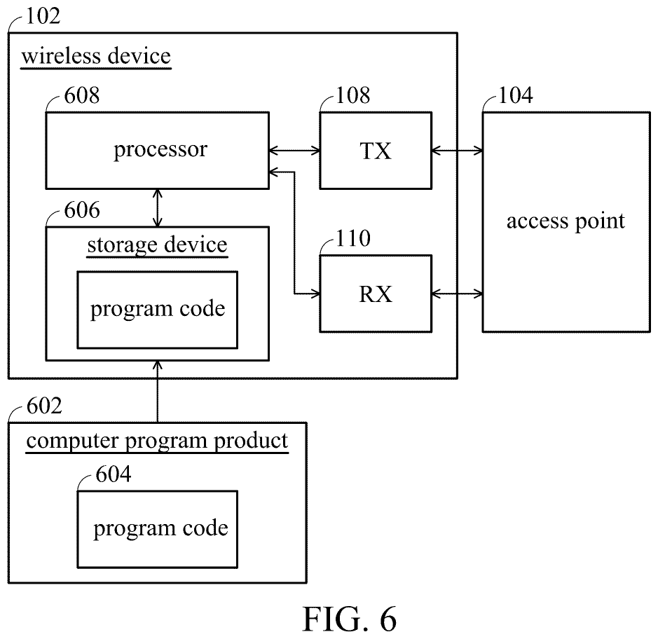

Based on the aforementioned concept, an initiative power-saving method for operating a wireless device is also presented in the disclosure, and the method may be coded and stored in a computer program product for sell. FIG. 6 illustrates a computer program product 602 storing program code 604 to be loaded into a storage device 606 of the wireless device 102 and executed by a processor 608 of the wireless device 102 to implement the initiative power-saving method. Accordingly, the transmitter 108 and the receiver 110 operate based on the aforementioned initiative power-saving mechanism.

Any wireless device operating a transmitter to do transmission of the transmission traffic of a target transmission in separated transmission windows, and having power-saving windows after each transmission window without transmitting any second-type null frame that carries the power-saving on information should be considered within the scope of the disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless device with an initiative power-saving mechanism, comprising:
a transmitter, transmitting packets to an access point, wherein the transmitter transmits a first-type null frame to the access point, and then transmits packets to the access point in multiple transmission windows;
wherein:
the first-type null frame carries power-saving off information;
each of the transmission windows is followed by a power-saving window without having the wireless device transmit any second-type null frame that carries power-saving on information;
the transmission windows are designed for an active mode; and
the power-saving windows are designed for a power-saving mode that consumes less power than the active mode.

2. The wireless device as claimed in claim 1, wherein:
the transmission windows for transmission of packets of a same target transmission task have the same length.

3. The wireless device as claimed in claim 2, wherein:
before the transmission of the packets of the same target transmission task is completed, all power-saving windows have the same length.

4. The wireless device as claimed in claim 1, wherein:
the greater throughput corresponds to the wider transmission window.

5. The wireless device as claimed in claim 1, wherein:
the greater throughput corresponds to the narrower power-saving window.

6. The wireless device as claimed in claim 1, further comprising:
a receiver, receiving packets from the access point, wherein, in response to a beacon, the wireless device transmits the first-type null frame to inform the access point that the wireless device starts a receiving window to receive packets, wherein
the receiving window is designed for the active mode and is controlled by a timer.

7. The wireless device as claimed in claim 6, wherein:
the wireless device further transmits the second-type null frame to the access point after the receiving window, to change to the power-saving mode.

8. The wireless device as claimed in claim 6, wherein:
the greater throughput corresponds to the wider receiving window.

9. An method for operating a wireless device, comprising:
transmitting a first-type null frame to an access point; and
performing a first transmission in a first transmission window that is followed by a first power-saving window and a second transmission window;
wherein:
the first-type null frame carries power-saving off information;
the first transmission window and the second transmission window are designed for an active mode;
the first power-saving window is designed for a power-saving mode that consumes less power than the active mode; and
the first power-saving window is invoked without transmission of a second-type null frame that carries power-saving on information.

10. The method as claimed in claim 9, wherein:
transmission windows for transmission of packets of a same target transmission task have the same length.

11. The method as claimed in claim 9, wherein:
before the transmission of the packets of the same target transmission task is completed, all power-saving windows following each transmission window have the same length.

12. The method as claimed in claim 9, wherein:
the greater throughput corresponds to the wider transmission window.

13. The method as claimed in claim 9, wherein:
the greater throughput corresponds to the narrower power-saving window.

14. The method as claimed in claim 9, further comprising:
in response to a beacon, transmitting the first-type null frame to inform an access point that the wireless device starts a receiving window to receive packets, wherein
the receiving window is designed for the active mode and is controlled by a timer.

15. The method as claimed in claim 14, further comprising:
transmitting the second-type null frame to the access point after the receiving window, to change to the power-saving mode.

16. The method as claimed in claim 14, wherein:
the greater throughput corresponds to the wider receiving window.

17. An method for operating a wireless device, comprising:
in response to a beacon, transmitting a first-type null frame to inform an access point that the wireless device starts a receiving window to receive packets,
wherein:
the first-type null frame carries power-saving off information; and
the receiving window is controlled by a timer, and is designed for an active mode that consumes more power than a power-saving mode.

18. The method as claimed in claim 17, further comprising:
transmitting a second-type null frame to the access point after the receiving window, to change to the power-saving mode, wherein
the second-type null frame carries power-saving on information.

19. The method as claimed in claim 17, wherein:
the greater throughput corresponds to the wider receiving window.
